(19) United States
(12) Patent Application Publication
(10) Pub. No.: US 2015/0331888 A1
(43) Pub. Date: Nov. 19, 2015

(54) IMAGE CAPTURE AND MAPPING IN AN INTERACTIVE PLAYBOOK

(71) Applicant: Ariel SHOMAIR, Toronto (CA)

(72) Inventor: Ariel SHOMAIR, Toronto (CA)

(21) Appl. No.: 14/279,993

(22) Filed: May 16, 2014

(51) Int. Cl. G06F 17/30; G06T 11/20; H04N 7/18; G06K 9/46; G06K 9/62

(52) U.S. Cl. CPC G06F 17/30259; G06K 9/46; G06K 9/6201; H04N 7/18; G06T 11/20

(57) ABSTRACT

This invention enables people to use paper-based templates as an “input device” for creative expression based games, animations, activities, and customization of physical goods (stickers, plates, etc.). Colored documents can be captured using a smartphone, tablet, or computer camera, and still enable the document contents to be correctly extracted (versus using a 2D capture device like a scanner). Custom-generate templates are created based on the specific requirements of the user (i.e. to produce a template which only has the necessary coloring items for the activity, versus all possible items). The contents can then be utilized in games, animations, activities, and the customization of physical goods.

### CROSS-REFERENCES TO RELATED APPLICATION

This application is a conversion to a non-provisional application of U.S. provisional patent application No. 61826889, entitled “IMAGE CAPTURE AND MAPPING IN AN INTERACTIVE PLAYBOOK”, filed with a receipt date of 23 May 2013.

### TECHNICAL FIELD

The present disclosure relates to computer vision, object recognition/identification, shape/pattern matching and recognition, interactive entertainment, children's toys.

### BACKGROUND

Traditionally, digital play on iPads™, mobile phones and computers is restricted to the confines of the device; for example, games and applications which solicit player's creative participation provide digital replicas of artistic instruments and tools to apply to a virtual canvas (i.e. a paintbrush tool in a drawing application). While these virtual implementations are programmed to attempt to mimic the output of their real world counterparts, the replicated experience is usually far from accurate for a number of reasons, such as differences in precision/accuracy, feedback, and the input device itself (touch/mouse instead of the actual drawing instrument).

For adults, this lack of precision and accuracy can become frustrating, as they are unable to express themselves with the level of fidelity they feel they could otherwise achieve on alternate mediums such as paper and pen. For children, this lack of precision and accuracy poses a potentially more serious developmental risk, as creative exploration is one of the means by which children develop essential fine motor and co-ordination skills.

Another issue with digital play is that it is usually done in solitude; the limited screen size of most touch-enabled device do not lend themselves as well to multi-player activities as large open workspaces. Children sit alone, with a screen close to their face, rather than in groups. These concerns have led a growing segment of parents to actively prevent their children from interacting with their phones and tabletsⁱ.

Yes, others have tried to solve the problem; Crayola™ has a line of “digitools” which attempt to recreate the feeling of real world play on an iPad™ (http://www.crayola.com/digitools), and SpinMaster™ Toys has create a line of “AppMATes” toys, which are designed to be used on the surface of an iPad™, integrated physical play with digital play (http://www.appmatestoys.com/).

Both provide a poor simulation of physical play though (as they require direct input on the 3″ to 10″ screen of the device), and do not solve the problem of enabling group play using a digital device.

Atlantic Magazine recently dedicated a cover article to the impact touch screens are having on children's development “The Touch-Screen Generation”, The Atlantic Magazine, Mar. 20 2013.

http://www.theatlantic.com/magazine/archive/2013/04/the-touch-screen-generation/309250/

A book has also recently been published on to the topic of how screen time affects children's development entitled Into the Minds of Babes: How Screen Time Affects Children from Birth to Age Five, by Lisa Guernsey

Accordingly, systems and methods that enable image capture and mapping to facilitate interactive playbooks remains highly desirable.

### BRIEF DESCRIPTION OF THE DRAWINGS

Further features and advantages of the present disclosure will become apparent from the following detailed description, taken in combination with the appended drawings, in which:

FIG. 1 shows a representation of a template image;

FIG. 2 shows a representation of a key mask image;

FIG. 3 shows a photograph of a template being colored;

FIG. 4 shows a photograph of image capture of the template;

FIG. 5A&B shows a captured image and the extracted document;

FIG. 6A-C shows the extracted document and the key mask to extract the template image;

FIG. 7 shows integration into an onscreen character;

FIG. 8 shows a method of an overall interaction process;

FIG. 9 shows a method of image detection and extraction process; and

FIG. 10 shows a computing device for executing the methods.

It will be noted that throughout the appended drawings, like features are identified by like reference numerals.

### DETAILED DESCRIPTION

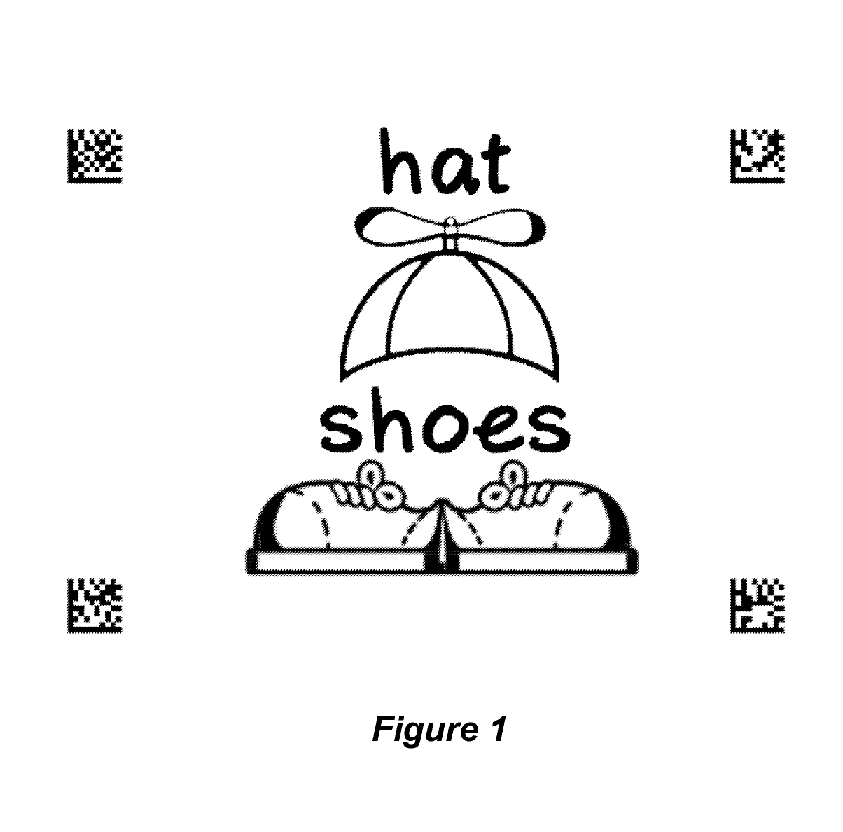

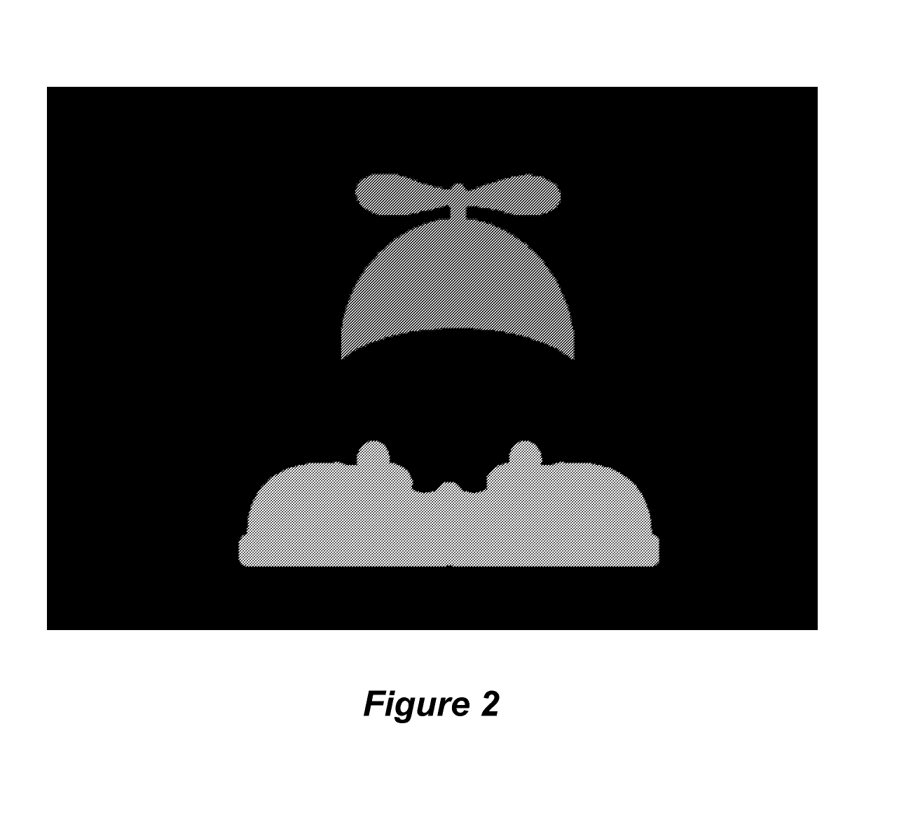

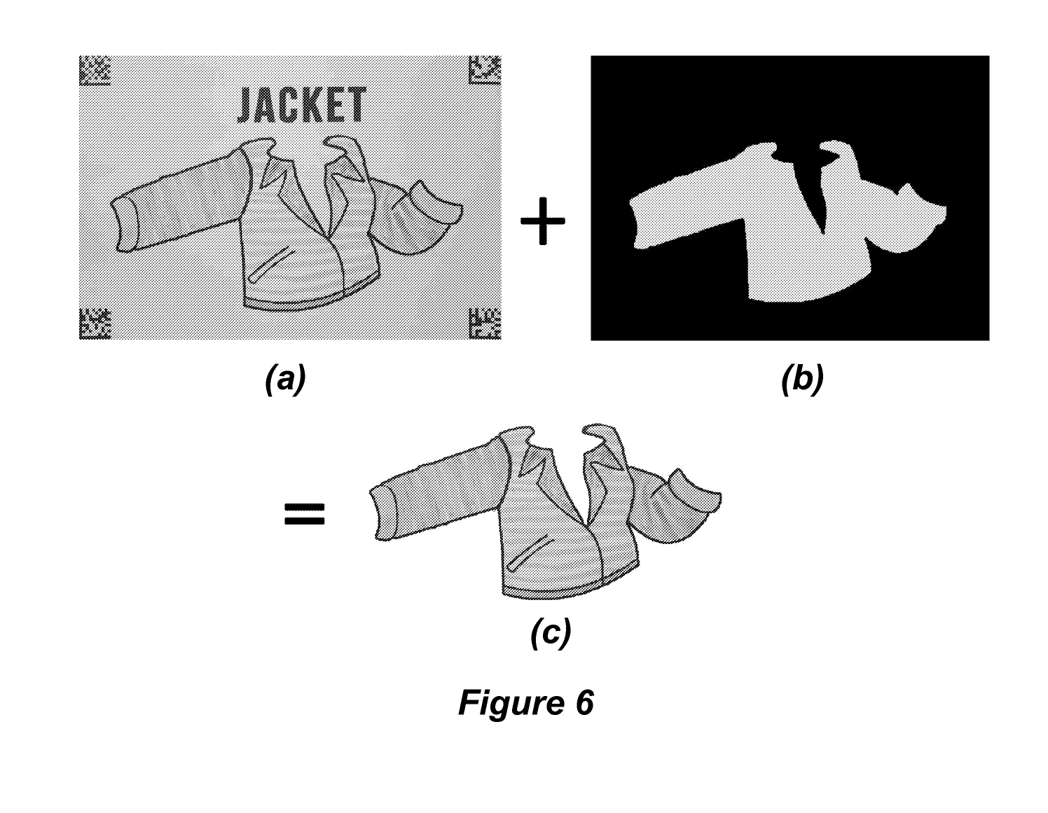

Embodiments are described below, by way of example only, with reference to FIGS. 1-10.

“Interactive Playbook” enables the use of customized creative elements within interactive experiences and physical goods. As shown in FIG. 1 a template is created which contains outlines of the areas the user is supposed to color/drawing within. A “key mask” image is also created which identifies what areas of the template that are later to be extracted. The key mask is an all black version of the image, with alternate colors used to identify the region which is to be extracted (each different color is viewed as a different region.

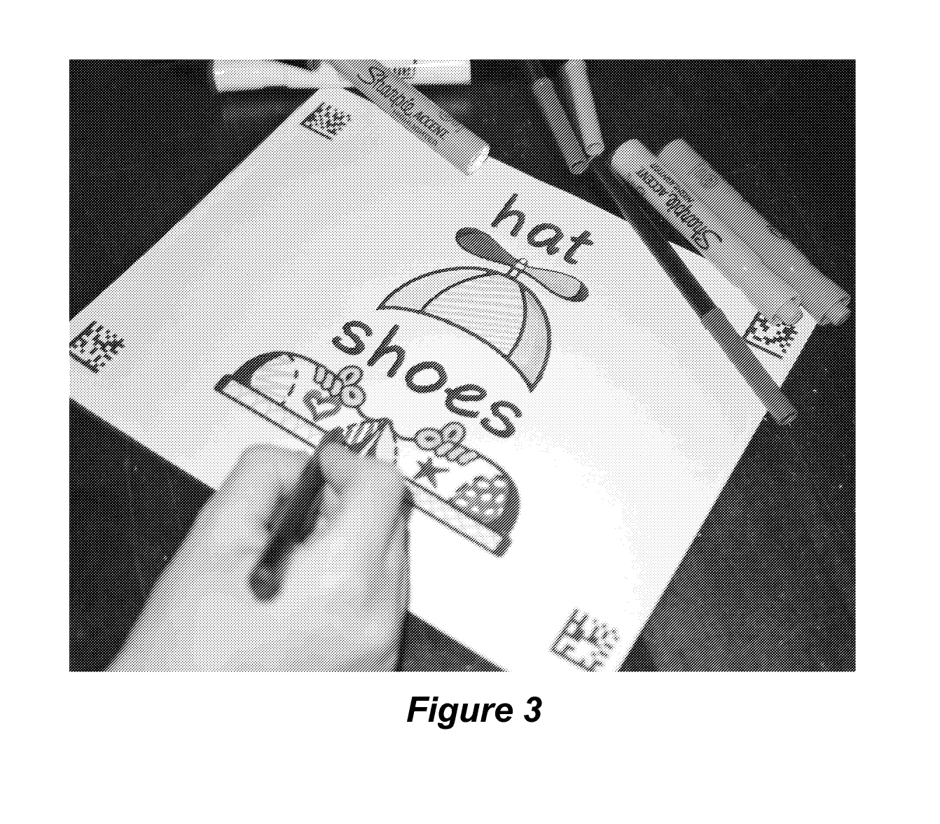

The template is either provided to the user as a digital file which they print themselves, or in a pre-printed format, such as a page within a book or magazine. As shown in FIG. 3 the user colors in the template with normal drawing utensils like pencils or pens, or uses other arts and crafts materials like stickers or paint.

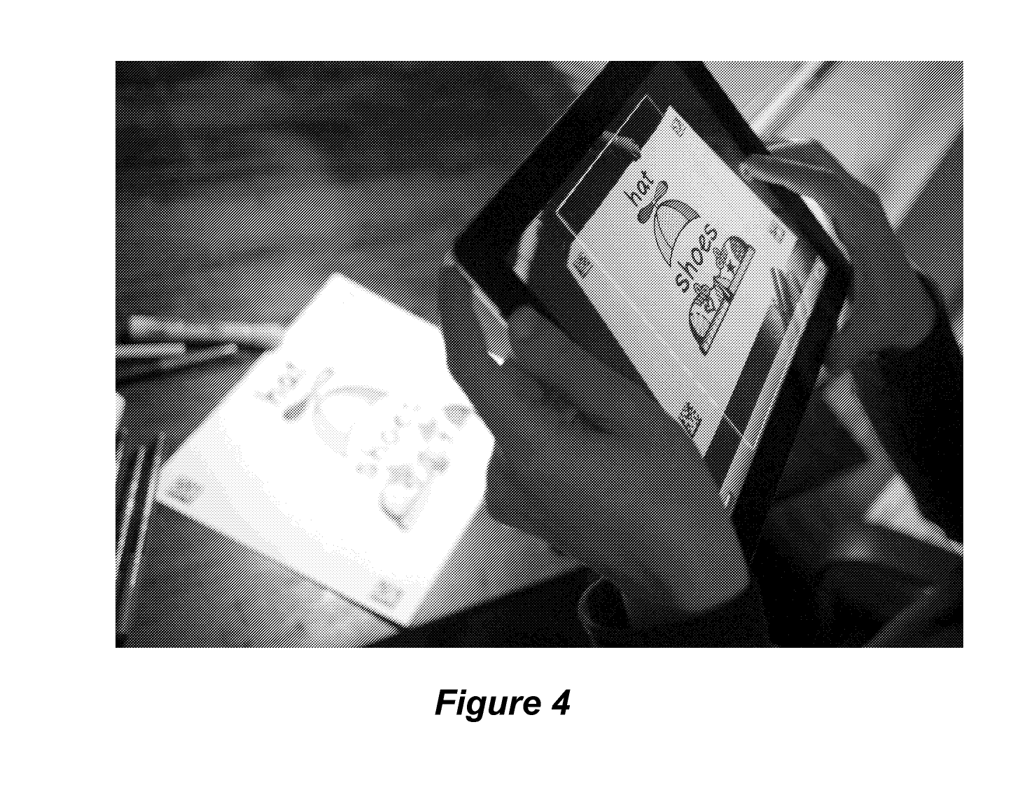

The user takes a photograph of their colored template as shown in FIG. 4 with a digital camera contained in a cell phone, tablet, desktop computer (or scanner), and uploads it to the Interactive Playbook software, which is either a tablet/phone/desktop application, or a website which the user visits.

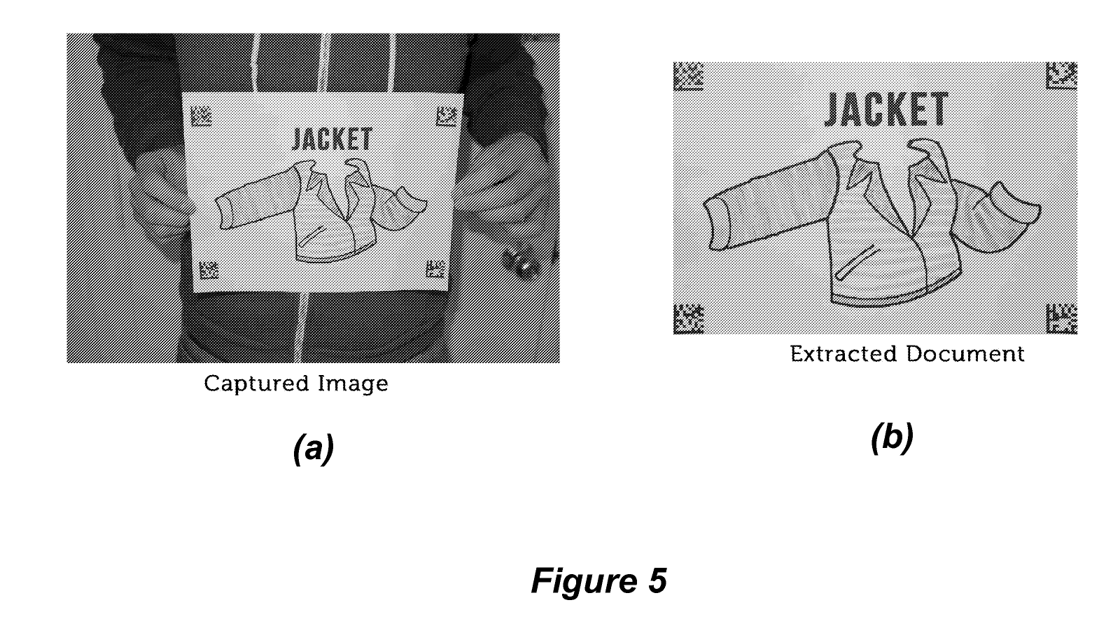

The interactive playbook software analyzes the submitted photograph as shown in FIG. 5(a), in order to identify where the colored paper template is located within the photograph. It then extracts the colored paper template from the surrounding area within the photograph by either looking for the corners of the page, or alternatively by using identification symbols in each corner, such as datamatrix codes or unique shapes as shown in FIG. 5(b). If necessary, image manipulations are used to rotate the template “right side up”, as well as adjust for any abbreviations or warping which occurred as a result of taking the photo on an angle (homography).

The software then takes the resulting “extracted document” from 5(b) and 6(a) and compares it with the original template image, along with the “key mask” 6(b) image, in order to extract the correct areas of the captured image. Each of these areas are extracted into their own separate document.

In order to be able to compare the extracted document with the original template image, the process must be able to correctly match the captured document to the original template in some fashion. This done in one of two ways:
(a) A unique identifying code can be stored on the document itself, either in the form of written text or code (such as QR or datamatrix), thereby providing a visual “lookup key” for what matching template should be used.
(b) Alternatively, a mathematically-derived “fingerprint” of the visual features of the extracted document image can be compared to a library of “fingerprints” from the possible templates, in order to match the extracted document with its appropriate original template image.

Depending on the final usage of the extracted area, image post-processing is then applied, in order to account for issues such as color balance, saturation and light exposure. For example, if the ultimate usage of the image is for an on-screen animation, the color balance may be adjusted in order to better match other colors on screen or if the destination is for a printed good such as a sticker, colors may be adjusted to meet the needs of the printer. Similarly, cell phone cameras commonly have LED flashes which give a very “blue” tinge to the images; the software may detect that “blueness” and automatically correct for it.

The final step of the process is the integration of the post-processed image 6(c) into the final piece of content—this could take a number of forms, such as:
The use of the user's design within an animation
The use of the user's design within an interactive video game
The use of the user's design as a “texture” on a 3D environment
The use of the user's design as a background in a 2D or 3D environment
The use of the user's design on a physical good, such as stickers, t-shirts, mugs, etc. . . .

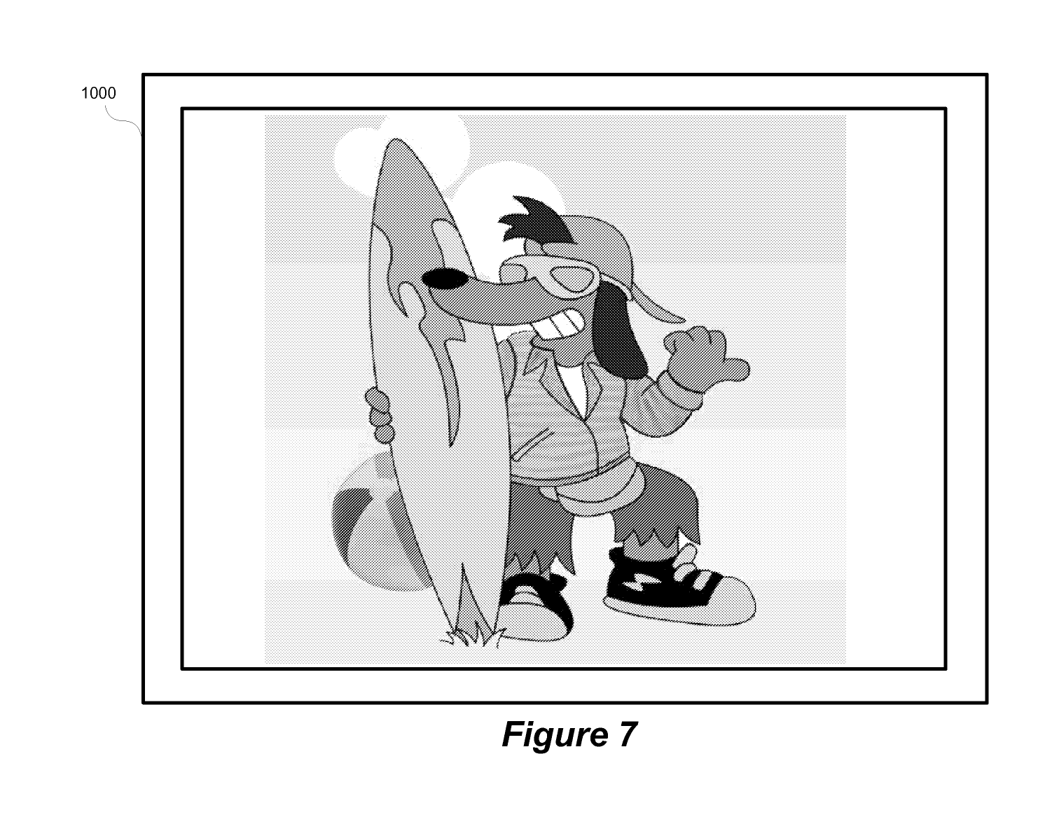

An example of integration into onscreen character is shown in FIG. 7. For example as displayed on a tablet 1000.

The image capture and mapping technique enables the core mechanic of enabling people to use paper-based templates as an “input device” for creative-expression based games, animations, activities, and customization of physical goods (stickers, plates, etc. . . . ). Colored documents can be captured in “3D Space”, using a smartphone, tablet, or computer camera, and still enable the document contents to be correctly extracted (versus using a 2D capture device like a scanner). Custom-generate templates are created based on the specific requirements of the user (i.e. to produce a template which only has the necessary coloring items for the activity, versus all possible items).

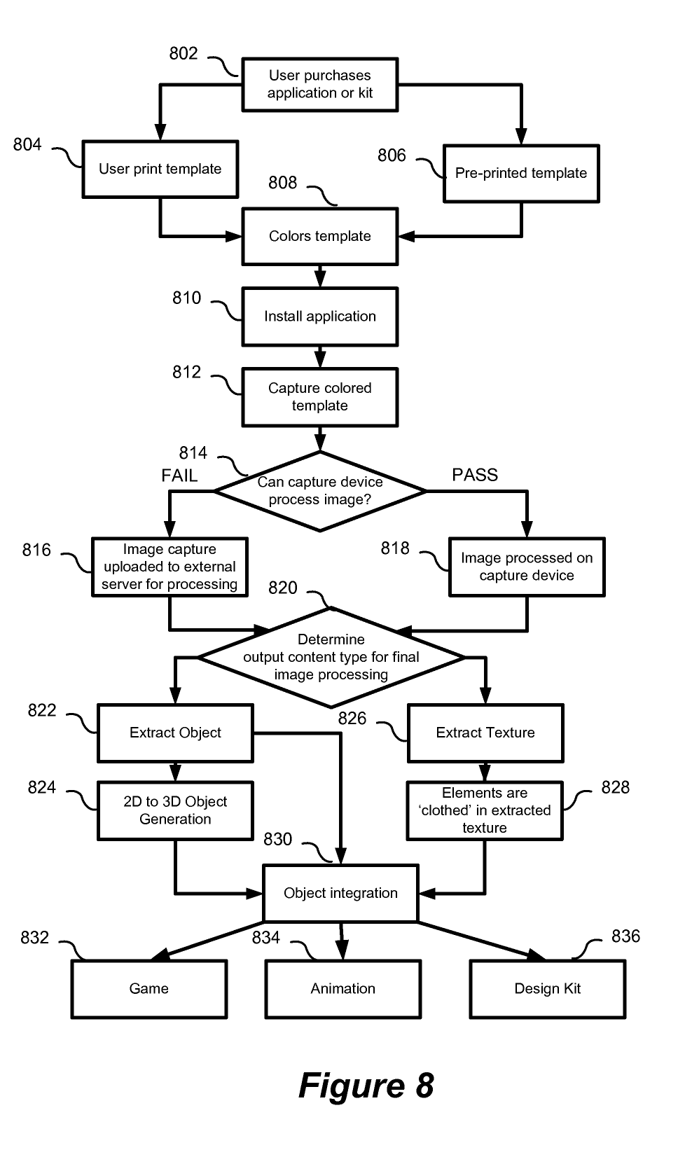

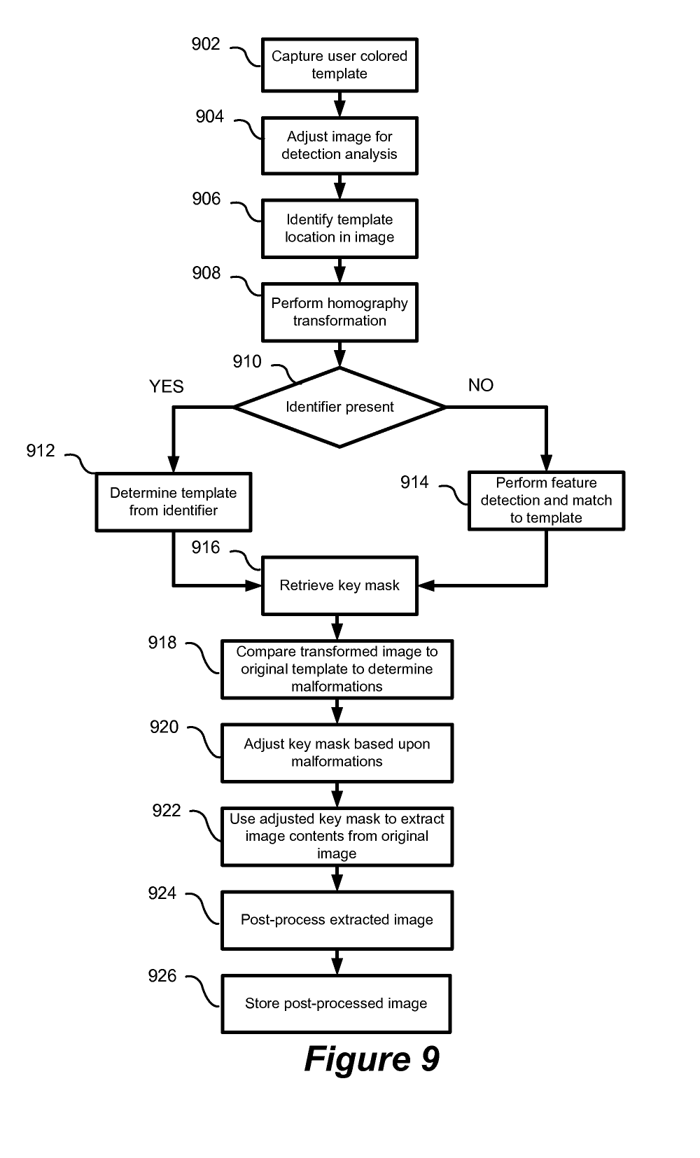

FIG. 8 shows a method of an overall interaction process. User visits a website, downloads an application, or makes a purchase which contains a customizable game, animation or design kit (802). User prints a digital template file, which is provided by either a download link, email attachment, or from physical media included with their purchase (CD Rom, USB Key, etc. . . . ) (804). The user's purchase includes a pre-printed workbook or worksheet(s) containing templates (806). User colors in the template with art utensils like pencils, markers, stickers or paint (808). User installs an application included with their purchase or accesses a website or application on their phone/tablet/computer (810). Using the application or website, user captures the contents of their colored template using a cell phone, tablet, desktop, or other similar digital capture device. (812). User's digital device is evaluated to determine if it is powerful enough to run the image extraction algorithms (814). If the digital device is not powerful enough (FAIL at 814) Image capture is uploaded to external server for image extraction processing (see IMAGE PROCESSING flowchart), resulting objects are returned to user (816). If the digital device is powerful enough (PASS at 814) Image capture is processed (See FIG. 9); relevant areas of image are extracted into independent objects (818). Output content type (game, storybook, animation, etc. . . . ) is evaluated to determine correct combination of final image processing and integration for each extracted object (820).

Object Extraction—A full section of the user's image is utilized as an object within the final output product—for example, a character, accessory, or background image. (822). 2D to 3D Object Generation—A 3D model is generated from the users 2D image for use in a 3D output product (824).

Texture Extraction—a portion of the user's image is utilized as a texture for either a 2D or 3D object. Texture synthesis may be employed in cases where the user's supplied texture is the incorrect dimensions (826). Elements are “clothed” in extracted texture, enabling them to be utilized in the generation of objects for the output product. (828).

Object Integration—The user's objects are integrated into the content of the game, animation or design kit, and saved (830). Such as:

Game—User's created objects are integrated into the game play—customized objects are persistent, and available in future game plays as well (832).

Animation—User's created objects are seamlessly integrated into the animation. Customized animation is saved for future re-watching (834).

Design kit—User's custom objects are sent to a printing or manufacturing facility, to enable the production of goods based on or containing the object's content (836).

FIG. 9 shows a method of image detection and extraction process. Image of the user-colored template is inputted using a digital capture device (camera, file upload) (902). A copy of the Image is created, whose brightness, contrast and size are adjusted in order to maximize ease of feature detection and analysis. This copy is used for all analysis, but not final output (904). The template's location within the captured image is determined by identifying corner markers, whose co-ordinates are then recorded, or by detecting the largest occurrence of the template shape within the image, and recording the co-ordinates of the corners of that shape (906). The transformed image is analyzed for presence of identifying signal, such as a Barcode or printed text/symbol (910). If a barcode or similar identifier/symbol is detected (YES at 910), the contents of the symbol is extracted and used to identify the original template which was printed and colored from a library of templates. (912). If no identifying signal is found (NO at 910), a feature detecting algorithm is used to compare the contents of the image with a library of possible templates to find a match. If a matching original template is found, it is associated with the image (914). The “key mask” for the template is retrieved from the library (916). A key mask is a copy of the original template which has had all content remove other than the areas which are to be extracted. Each area which is to be extracted uniquely has an identifying characteristic, such as being filled with a specific color, shade or pattern, or by having a unique symbol embed within it. Each original template in the library has a “key mask” associated with it. The transformed user's image is compared to the original template image using a feature detection algorithm, in order to further adjust for any malformations which may have taken place through the capture stage (918). The key mask is then adjusted based on the malformations identified in the previous step (920). The adjusted key mask is then used to extract the image contents from the original image. Each unique area of the key mask results in a unique extracted image; for example, if color shade is being used to identify unique areas, the image contents will be extracted sequentially from the darkest colored area to lightest color area (922). The extracted image areas are post-processed in order to account for issues such as color balance, saturation and light exposure. For example, cell phone cameras commonly have LED flashes which give a very “blue” tinge to the images; the software may detect that “blueness” and automatically correct for it using an auto-white balance algorithm (924). Post-processed images are then either saved to file, or pushed directly to the next stage of processing (926).

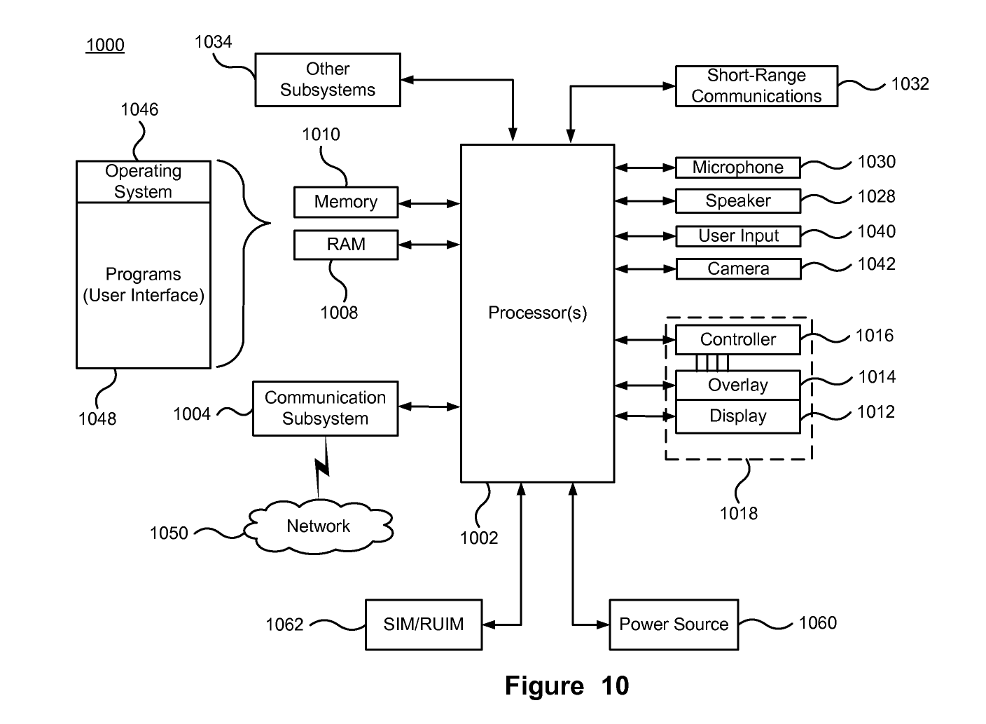

FIG. 10 is a schematic depiction of an example electronic device capable of capturing an image and mapping as described herein. As shown by way of example in FIG. 10, the electronic device 1000, includes a processor (or microprocessor) 1002 for executing instructions, including instructions for providing one or more applications, memory in the form of flash memory 1010 and RAM 1008 (or any equivalent memory devices) for storing an operating system 1046 and one or more applications, components or functionalities 1048 providing the graphical user interface with which the user interacts with the device for viewing content and facilitating mapping of captured template images for generation of an interactive palybook. The processor receives power from a power supply 1060, which may be a direct connection or provided by a battery source.

As shown by way of example in FIG. 10, the electronic device 1000 may include a communication subsystem 1004 which provides radiofrequency (RF) transceiver to communicate through a wireless network 1050. The electronic device 1000 may be in a portable form factor such as a smart phone, tablet, netbook, laptop, ultrabook, portable computing device or an integrated mobile computer device. The electronic device 1000 may access wired or wireless networks to transmit and retrieve data. The RF transceiver for communication with a wireless network 1050 using a wireless communication protocols such as, for example but not limited to, GSM, UMTS, LTE, HSPDA, CDMA, W-CDMA, Wi-MAX, Wi-Fi etc. A subscriber identity module (SIM) card 1062 may be provided depending on the access technology supported by the device. The communication subsystem 1004 may also provide wired communication through a network.

Optionally, where the device is a voice-enabled communications device such as, for example, a tablet, smart-phone or cell phone, the device would further include a microphone 1030 and a speaker 1028. Short-range communications 1032 is provided through wireless technologies such as Bluetooth™ or wired Universal Serial Bus™ connections to other peripheries or computing devices or by other device sub-systems 1034 which may enable access tethering using communications functions of another mobile device. In a tethering configuration the electronic device 1000 may provide the network information associated with the tethered or master device to be used to access the network. The device 1000 may optionally include a Global Positioning System (GPS) receiver chipset or other location-determining subsystem.

The operating system 1046 and the software components that are executed by the microprocessor 1002 are typically stored in a persistent store such as the flash memory 1010, which may alternatively be a read-only memory (ROM) or similar storage element (not shown). Those skilled in the art will appreciate those portions of the operating system 1046 and the software components, such as specific device applications, or parts thereof, may be temporarily loaded into a volatile store such as the RAM 1008. Other software components can also be included, as is well known to those skilled in the art.

User input 1040 may be provided by integrated input devices such as a keyboard, touchpad, touch screen, mouse, camera or positing apparatus to actuate transitions. A camera 1042 is provided for capturing the template image. The electronic device 1000 may have an integrated touch-sensitive display 1018 having a display screen 1012, with a touch-sensitive overlay 1014 coupled to a controller 1016 for enabling interaction with the electronic device 1000. The display portion of the electronic device 1000 may not necessarily be integrated but may be coupled to the electronic device 1000.

Although certain methods, apparatus, computer readable memory, and articles of manufacture have been described herein, the scope of coverage of this disclosure is not limited thereto. To the contrary, this disclosure covers all methods, apparatus, computer readable memory, and articles of manufacture fairly falling within the scope of the appended claims either literally or under the doctrine of equivalents.

Although the following discloses example methods, system and apparatus including, among other components, software executed on hardware, it should be noted that such methods, system and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods and apparatus, persons having ordinary skill in the art will readily appreciate that the examples provided are not the only way to implement such methods, system and apparatus.

1. A method of generating an interactive playbook comprising:
receiving an image of a paper based drawing;
determining an associated template and key mask from the capture image;
applying key mask to captured image;
transforming the captured image relative to the determined template; and
integrating the captured image into content based upon the template.
